(19) United States
(12) Patent Application Publication
(10) Pub. No.: US 2009/0283232 A1
(43) Pub. Date: Nov. 19, 2009

(54) PAPER AND PAPERBOARD PRODUCTION PROCESS AND CORRESPONDING NOVEL RETENTION AND DRAINAGE AIDS, AND PAPERS AND PAPERBOARDS THUS OBTAINED

(75) Inventors: Rene' Hund, Villars (FR); Christian Jehn-Rendu, Cedex 01 (FR)

Correspondence Address: RICHARD M. SACCOCIO, ESQ.;DOMINIK, STEIN, SACCOCIO, REESE, COLITZ, & VAN DER WALL, 6175 NORTHWEST 153RD STREET - SUITE 225, MIAMI LAKES, FL, 33014, US

(73) Assignee: SNF SA, Saint Etienne Cedex 01 (FR)

(21) Appl. No.: 12/511,044

(22) Filed: Jul. 28, 2009

Related U.S. Application Data
(63) Continuation of application No. 11/338,762, filed on Jan. 25, 2006, now abandoned.
Application No. 11/338,762 is a continuation of application No. 10/653,288, filed on Sep. 3, 2003, now abandoned.
Application No. 10/653,288 is a continuation of application No. 09/701,556, filed on Mar. 16, 2001, now abandoned.

(30) Foreign Application Priority Data
Jun. 4, 1998 (FR) 98/07144

(51) Int. Cl. D21H 17/37; C08F 220/56

(52) U.S. Cl. 162/164.6; 162/168.1; 526/307.3

(57) ABSTRACT

The invention concerns an improved method for making paper, which uses a branched polymer prepared in invert emulsion as the main retention agent, and bentonite as a secondary retention agent (dual type system). The two additions are separated by a step for shearing the fibrous suspension (or mass). The invention results in highly improved retention and also highly improved dewatering. Moreover, it enables the bentonite content in white water to be reduced.

This nonprovisional application is a continuation application of application Ser. No. 11/338,762 filed on Jan. 25, 2006, which is a continuation application of application Ser. No. 10/653,288 filed on Sep. 3, 2003, which is a continuation application of application Ser. No. 09/701,556 filed on Mar. 16, 2001, which is a National Stage entry of International Application No. PCT/FR99/01278 filed on Jun. 1, 1999, which claims priority to French Application No. 98/07144 filed on Jun. 4, 1998. The disclosures of the prior applications are hereby incorporated herein in their entirety by reference.

The present invention relates to the technical field of paper production and the polymers used in this field.

The invention relates to a process for producing a paper or paperboard with improved retention and other properties.

During the production of paper, paperboard, or the like, it is well known to introduce into the pulp retention aids whose function is to retain a maximum of fines and fillers in the sheet. The beneficial effects that result from the utilization of a retention aid are essentially:
increased production and reduction of production costs: energy savings, more reliable operation of the machine, higher yield in terms of fibers, fines, fillers and anionic finishing products, lower acidity in the circuit linked to a decrease in the use of aluminum sulfate, and hence a reduction in corrosion problems;
an improvement in quality: better formation and better look-through, an improvement in the moisture content, the opacity, the gloss, and the absorptive capacity of the sheet, and a reduction in the porosity of the paper.

Long ago, it was proposed that bentonite be added to the pulp, possibly together with other mineral products such as aluminum sulfates or even synthetic polymers, notably polyethylene imine (see for example the documents DE-A-2 262 906 and U.S. Pat. No. 2,368,635).

In the document U.S. Pat. No. 3,052,595, it was proposed to associate the bentonite with a polyacrylamide of an essentially linear nature. This process met with competition from systems that were easier to use yet performed just as well. Moreover, even with the current linear polyacrylamides, the retention capacity is still insufficient.

In the document EP-A-0 017 353, it was proposed, for the retention of low-filler pulps (less than 5% fillers), to associate the bentonite with a nonionic to slightly anionic linear copolyacrylamide. This process has not been very widely used, since these polymers perform relatively poorly in terms of retention, especially that of pulps containing fillers, no doubt as a result of insufficient synergy between these copolymers and bentonite, which does not have much of a tendency to recoagulate.

In the document EP-A-0-235 893, it was proposed to use essentially linear cationic polyacrylamides having molecular weights of greater than one million, of thirty million and higher. This results in the obtainment of a retention effect that is satisfactory, but is still deemed inadequate in the papermaking application; since the use of bentonite causes problems during the subsequent treatment of the effluents issuing from the machine, users select this system only if there are significant advantages.

In the notes presented at the lecture given in Seattle on Oct. 11-13, 1989, published under the title “Supercoagulation in the control of wet end chemistry by synthetic polymer and activated bentonite,” R. Kajasvirta described the mechanism of supercoagulation of activated bentonite in the presence of a cationic polyacrylamide, without specifying its exact nature. This process has the same drawbacks as above.

Lastly, European Patent 0 574 335 produced an important improvement by proposing the use branched polymers (particularly polyacrylamides) in powder form.

The invention eliminates the drawbacks mentioned above.

### BRIEF DESCRIPTION OF THE DRAWINGS

FIGS. 1-10 are histograms showing the data obtained as a result of the analyses performed in Example 1.

FIGS. 11-20 are histograms showing the data obtained as a result of the analyses performed in Example 2.

### DETAILED DESCRIPTION OF THE INVENTION

The object of the invention is to obtain an improved process of the type in question, which is comprised of adding to the suspension or fibrous mass or paper pulp to be flocculated, as the main retention aid, an agent consisting of or comprising a branched polyacrylamide which is: characterized in that it has been prepared in reverse phase or water-in-oil emulsion, and bentonite as the second retention aid (a so-called “dual” system of the type also known as “microparticulate”).

The phrase “exists in reverse phase emulsion” or similar expressions related to the polymer used (i.e., injected or introduced into the pulp to be flocculated) according to the invention, will be understood by one skilled in the art to designate the reverse phase water-in-oil emulsion that is dissolved in water before its injection or its introduction into the mass or pulp to be flocculated (this dissolution in water results in what is known as the “reversal” of the initial reverse phase water-in-oil emulsion; these processes are well known to one skilled in the art).

The additions of the polymer and the bentonite are separated by a shearing stage, for example at the level of the mixing pump known as a “fan pump.” In this field, the reader is referred to the specification of U.S. Pat. No. 4,753,710, as well as to a vast body of prior art related to the addition point of the retention aid relative to the shearing stages existing in the machine, including U.S. Pat. No. 3,052,595; Unbehend, TAPPI Vol. 59, No. 10, October, 1976; Luner, 1984 Papermakers Conference or TAPPI, April, 1984, pp. 95-99; Sharpe, Merck and Co., Inc., Rahway, N.J., USA, around 1980, Chapter 5, “Polyelectrolyte Retention Aids”; Britt, TAPPI Vol. 56, October 1973, p. 46 ff.; and Waech, TAPPI, March, 1983, p. 137; or even U.S. Pat. No. 4,388,150 (Eka Nobel).

The reader is also referred to U.S. Pat. No. 4,753,710 for all of the generalities related to paper production, the usual additives used, and similar details.

It is possible to replace the bentonite, as the secondary retention aid, with a kaolin, as described in the Applicant's French patent application 95 13051, this kaolin preferably being pretreated with a polyelectrolyte. One skilled in the art can refer to this French patent application 95 13051.

This process makes it possible to obtain a distinctly improved retention of fines and fillers without a reverse effect. An additional characteristic of this improvement is that the drainage properties are improved.

The branched polyacrylamide (or more generally the branched (co)polymer) is introduced into the suspension, in a distinctly preferred way, in the form of a reverse phase water-in-oil emulsion at a rate of 0.03 to one per mill (0.03 to 1%, or 30 to 1,000 g/t) by weight of active material (polymer) relative to the dry weight of the fibrous suspension, preferably 0.15 to 0.5 per mill, or 150 to 500 g/t.

In a way that is known to one skilled in the art, the reverse phase emulsion polymer is diluted in water and inverted (solubized) by this dilution before its introduction, as described above.

This selection of the reverse phase emulsion form makes it possible, in the papermaking application for the retention of fillers and fines, to reach a level of performance unequalled up to now. Moreover, the utilization of branched polymers makes it possible to obtain a better retention of the bentonite in the sheet, as described in the above-mentioned European patent 0 574 335, and thus to limit its negative effects on the subsequent treatment of the effluents issuing from the machine. Furthermore, the choice of this branched polyacrylamide increases the fixation capacity of the bentonite in the sheet, consequently resulting in a synergy, and hence a recoagulation, which reduces the bentonite content in the white water.

It is understood that it is essential according to the invention that the polymer be prepared by means of a reverse phase oil-in-water emulsion polymerization. However, this polymer can then be used (i.e., injected or introduced into the mass or pulp to be flocculated) either in the form—preferably—of this reverse phase emulsion after its dissolution in water, or in the form of a powder obtained by drying (especially drying by means of “spray drying”) the reverse phase emulsion from the polymerization, and then redissolving this powder in water, for example at a concentration on the order of 5 g of active polymer/liter, the solution thus obtained then being injected into the pulp at substantially the same polymer dosages.

Advantageously, in practice, the branched (co)polyacrylamide is a cationic copolymer of acrylamide and of an unsaturated cationic ethylenic monomer, chosen from the group comprising dimethylaminoethyl acrylate (ADAME), dimethylaminoethyl methacrylate (MADAME), quaternized or salified by different acids and quaterinizing agents, benzyl chloride, methyl chloride, alkyl or aryl chloride, dimethyl sulfate, diallyldimethylammonium chloride (DADMAC), acrylamidopropyltrimethyaammonium chloride (APTAC), and methacrylamidopropyltrimethylammonium chloride (MAPTAC).

In a known way, this copolymer is branched by a branching agent constituted by a compound having at least two reagent groups chosen from the group comprising the double bonds, aldehyde bonds, or epoxy bonds. These compounds are well known and are described, for example, in the document EP-A-0 374 458 (see also the Applicant's document FR-A-2 589 145).

As is known, a “branched” polymer is a polymer that has in the chain branches, groups or branchings globally disposed in one plane and not in the three directions, unlike a “cross-linked” polymer; branched polymers of this type, of high molecular weight, are well known as flocculating agents. These branched polyacrylamides are distinguished from the cross-linked polyacrylamides by the fact that in the latter, the groups are disposed three dimensionally so as to lead to practically insoluble products of infinite molecular weight.

The branching can be carried out preferably during (or possibly after) the polymerization, for example by reaction of two soluble polymers having counter-ions, or by reaction on formaldehyde or a polyvalent metal compound. Often, the branching is carried out during the polymerization by the addition of a branching agent, and this method is clearly preferred according to the invention. These processes for polymerization with branching are well known.

The branching agents that can be incorporated comprise ionic branching agents such as polyvalent metal salts, formaldehyde, glyoxal, or even, preferably, covalent cross linkers that will copolymerize with the monomers, preferably monomers with diethylenic unsaturation (like the family of diacrylate esters such as the diacrylates of polyethylene glycol PEG) or polyethylenic unsaturation, of the type classically used for the cross-linking of water-soluble polymers, and particularly methylenebisacrylamide (MBA), or any of the other known acrylic branching agents.

These agents are often identical to the cross linkers, but cross-linking can be avoided when desiring to obtain a polymer that is branched but not cross-linked, by optimizing polymerization conditions such as the concentration of the polymerization, type and quantity of transfer agent, temperature, type and quality of initiators, and the like.

In practice, the branching agent is methylenebisacrylamide (MBA), introduced at a rate of five to two hundred (5 to 200) moles per million moles of monomers, preferably 5 to 50.

Advantageously, the quantity of branched polyacrylamide introduced into the suspension to be flocculated is between thirty and one thousand grams of active polymer/ton of dry pulp (30 and 1,000 g/t), or between 0.03 per mill and one per mill, preferably 150 to 500 g/t; it was observed that if the quantity is lower than 0.03% (0.03 per mill), no significant retention is obtained; likewise, if this quantity exceeds 1% (1 per mill), no proportional improvement is observed; however, unlike the linear cationic polyacrylamides, as described in the documents EP-A-0 017 353 and EP 0 235 893 mentioned in the preamble, there is no observed reverse dispersion effect by recirculation in the closed circuits of the excess polymer not retained in the sheet. Preferably, the quantity of branched polyacrylamide introduced is between 0.15 and 0.5 per mill (0.15 and 0.5%) of the quantity of dry pulp, or between 150 g/t and 500 g/t.

As stated above, it is important that the branched polymer be prepared in reverse phase (water-in-oil) emulsion form in order to achieve the improvement of the invention. Emulsions of this type and the process for preparing them are well known to one skilled in the art.

This approach was condemned in the above-mentioned European patent 0 574 335, in which it was indicated that if a branched polymer is used in emulsion, the indispensable presence of surfactants in these emulsions promotes the formation of foams during the production of the paper and the appearance of disparities in the physical properties of the finished paper (modification of the absorbency in the places where part of the oil phase of the emulsion is retained in the sheet).

Therefore, it was not obvious to consider a fortiori the reverse phase water-in-oil emulsions whose oil content is clearly high.

The invention was even more difficult to achieve in that it was important to stay within the field of branched polymers and not to cross over to the field of cross-linked polymers. It is known that technically, especially on an industrial production scale, the borderline between the two areas is very easily crossed, in a way that is, moreover, irreversible. Since the branched area is very limited, the difficulty of developing the invention is considerable, and the Applicant deserves credit for undertaking to use of this technology in the field of paper production, which poses particular problems and has strict quality requirements.

The risk of failure, which may explain the fact that this technology had not been used, was even greater in that cross linked emulsions are not known to provide any particular advantage in paper.

In comparison with the linear polymers, the branched polymers in powder form of the above-mentioned European patent 0 574 335 had already made substantial progress relative to the properties and the paper production process. The improvement was on the order of 20 to 40% depending on the properties.

With the present branched emulsions, an improvement on the order of 50 to 60% is obtained, which would not have been foreseeable since, on the contrary, it was known that the cross linked products did not work.

According to the invention, in a preferred but non-limiting way, a “moderately branched” polymer is used, for example with 10 ppm of branching agent relative to the active material.

As already indicated above, the polymer can be used either in the form of its synthetic reverse-phase emulsion, dissolved or “inverted” in water, or in the form of the solution in water of the powder obtained by drying said synthetic: emulsion, particularly by means of spray-drying. Spray-drying is a process that is also known to one skilled in the art. The reader is referred to the tests below in order to verify that the results are comparable.

Bentonite, also known as “smectic swelling clay,” from the montmorillonite family, is well known and there is no need to describe it in detail here; these compounds, formed of microcrystallites, comprise surface sites having a high cation exchange capacity capable of retaining water (see for example the document U.S. Pat. No. 4,305,781, which corresponds to the document EP-A-0 017 353 mentioned above, and FR-A-2 283 102).

Preferably, a semisodic bentonite is used, which is introduced just upstream from the headbox, at a rate of 0.1 to 0.5 percent (0.1 to 0.5%) of the dry weight of the fibrous suspension.

As a filler, it is possible to use kaolins, GCC or ground CaCO₃, precipitated CaCO₃ or PCC, and the like.

The branched polymer in reverse phase emulsion according to the invention is injected or introduced prior to a shearing stage into the paper pulp (or fibrous mass to be flocculated), which is more or less diluted according to the experience of one skilled in the art, and generally into the diluted paper pulp or “thin stock,” i.e. a pulp diluted to about 0.7 to 1.5% solid matter such as cellulose fibers, possible fillers, and the various additives commonly used in papermaking.

According to a variant of the invention with fractionated introduction, some of the branched polymer in emulsion according to the invention is introduced at the level of the stage for preparing the “thick stock” with about 5% or more solid matter, or even at the level of the preparation of the thick stock before a shearing stage.

The following examples illustrate the invention without limiting its scope.

### Example 1

### Production of a Branched Polymer in the Form of a Reverse Phase Water-in-Oil Emulsion

In a reactor A, the constituents of the organic phase of the emulsion to be synthesized are mixed at the ambient temperature.
a) Organic phase
   252 g of Exxsol D100
   18 g of Span 80
   4 g of Hypermer 2296
b) In a beaker B, the aqueous phase of the emulsion to be produced is prepared by mixing:
   385 g of acrylamide at 50%
   73 g of ethyl acrylate trimethyl ammonium chloride 80%
   268 g of water
   0.5 g of methylenebisacrylamide at 0.25%
   0.75 ml of sodium bromate at 50 g 1⁻¹
   20 ppm of sodium hypophosphite relative to the active material
   0.29 ml of Versenex at 200 g 1⁻¹

The contents of B are mixed into A under agitation. After the mixing of the phases, the emulsion is sheared in the mixer for 1 minute in order to create the reverse phase emulsion. The emulsion is then degassed by means of a nitrogen bubbling; then after 20 minutes the gradual addition of the metabisulfite causes the initiation followed by the polymerization.

Once the reaction is finished, a “burn out” (treatment with the metabisulfite) is carried out in order to reduce the free monomer content.

The emulsion is then incorporated with its inverting surfactant in order to subsequently release the polymer in the aqueous phase. It is necessary to introduce 2 to 2.4% ethoxylated alcohol. The standard Brookfield viscosity of said polymer is 4.36 cps (viscosity measured at 0.1% in a 1 M NaCl solution at 25° C. at sixty rpm).

In accordance with a variation of the MBA content from 5 to 20 ppm, the results in terms of UL viscosity are the followings

### Table of Example 1:

| | | | | IR | | |
|---|---|---|---|---|---|---|
| | MBA | NaH₂PO₂ | UL | (1) | IVR (2) | |
| Test | ppm | ppm (*) | Viscosity | (%) | (%) | State |
| R 52 | 5 | 20 | 4.56 | 12.8 | 0 | Branched |
| R 102 | 10 | 20 | 3.74 | 28.9 | 0 | Branched |
| SD 102 | 10 | 20 | 3.70 | 26 | 0 | Branched |
| X 104 | 10 | 40 | 2.31 | 45 | 50 | Cross- |
| | | | | | | linked |
| X 204 | 20 | 40 | 2.61 | 54.8 | 50 | Cross- |
| | | | | | | linked |
| EM 140CT | 0 | 15 | 4.5 | 0 | <0 | Linear |
| EM 140L | 0 | 30 | 3.82 | 0 | 0 | Linear |
| EM 140LH | 0 | 40 | 3.16 | 0 | <0 | Linear |
| EM 140BD | 5 | 0 | 1.85 | 80 | 100 | Cross- |
| | | | | | | linked |
| FO 4198 | 5 | 20 | 3.2 | 5 | <0 | Branched |

FO 4198: a branched powder containing 20 ppm transfer agent and 5 ppm branching agent.
(*) sodium hypophosphite, transfer agent
(1) ionic regain in %
(2) intrinsic viscosity regain in %
EM140CT: a standard emulsion of very high molecular weight containing no branching agent
EM 140L: a standard emulsion of high molecular weight containing no branching agent
EM140LH: an emulsion of average molecular weight containing no branching agent
EM140BD: a cross-linked emulsion containing no transfer agent and 5 ppm cross linker
SD 102: the emulsion R 102 dried by spray-drying, and the powder obtained dissolved in water to 5 g of active polymer/liter

It is noted that the linear products do not develop any ionic regain IR, and their intrinsic viscosity IV decreases under the effect of an intense shearing (two of the IV values are negative); the branched products in emulsion develop an ionic regain IR, but no IV (values <=0); the cross-linked products develop a high ionic regain and a very high IV regain.

### DEFINITIONS OF THE IONIC REGAINS AND INTRINSIC VISCOSITY REGAINS

Ionic regain IR=(X−Y)/Y×100
with X: ionicity after shearing in meq/g.
Y: ionicity before shearing in meq/g.
Intrinsic viscosity regain IVR=(V1−V2)/V2×100
with V1: intrinsic viscosity after shearing in dl/g
V2: intrinsic viscosity before shearing in dl/g

Some of the emulsions cited above will be the subjects of a study of effectiveness in retention and drainage in an automated sheet former at the Center for Paper Technology.

### Procedure for Testing the Emulsions

### Pulp Used:

| | |
|---|---|
| mixture of 70% bleached hardwood kraft | KF |
| 10% bleached softwood kraft | KR |
| 20% mechanical pulp | PM |
| 20% natural calcium carbonate. | |

Sizing in a neutral medium with 2% of an alkyl ketene dimer emulsion.

The pulp used is diluted to a consistency of 1.5%. A sample of 2.24 dry g of pulp, or 149 g of pulp at 150%, is taken, then diluted to 0.4% with clear water.

The 560 ml volume is introduced into the plexiglass cylinder of the automated sheet former, and the sequence is begun.

| | |
|---|---|
| t = 0 s, | start of agitation at 1500 rpm. |
| t = 10 s, | addition of the polymer. |
| t = 60 s, | automatic reduction to 1000: rpm and, if necessary, addition |
| | of the bentonite. |
| t = 75 s, | stopping of the agitation, formation of the sheet with vacuum |
| | under the wire, followed by reclamation of the white water. |

The following operations are then carried out:
measurement of the turbidity of the water under the wire.
dilution of a beaker of thick stock for a new sheet with the reclaimed water under the wire.
drying of the so-called 1st pass sheet.
start of a new sequence for producing the so-called 2nd pass sheet.

After 3 passes, the products to be tested are changed.

The following analyses are then performed:
measurement of the matter in suspension in the water under the
measurement of the ash in the sheets (TAPPI standard: T 211 om-93)
measurement of turbidity 30′ after the fibers are deposited in order to learn the state of the ionic medium.
measurement of the degree of drainability of the pulp with a Canadian Standard Freeness (CSF; TAPPI standard T 227 om-94).

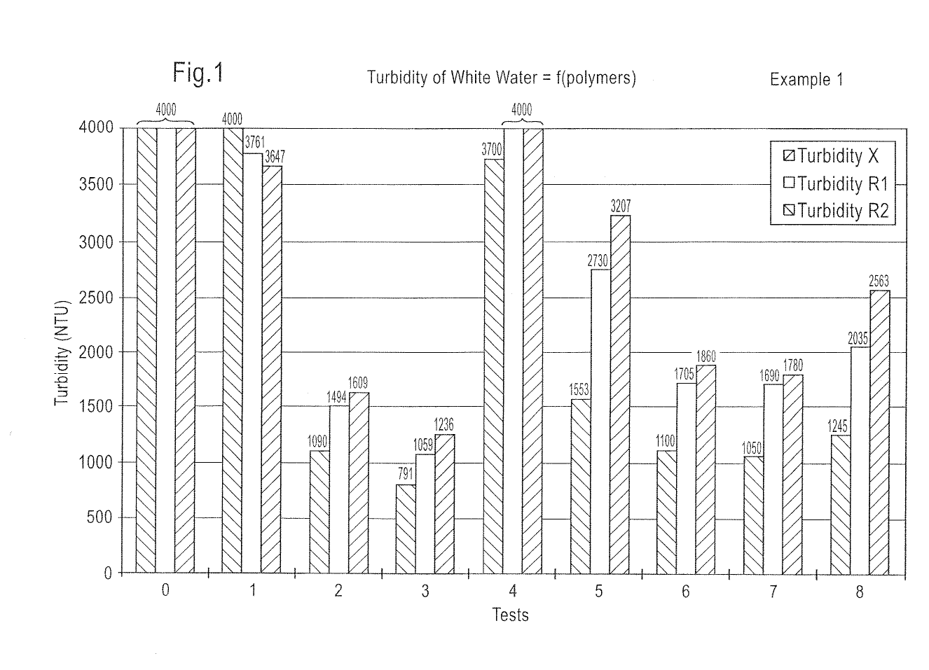

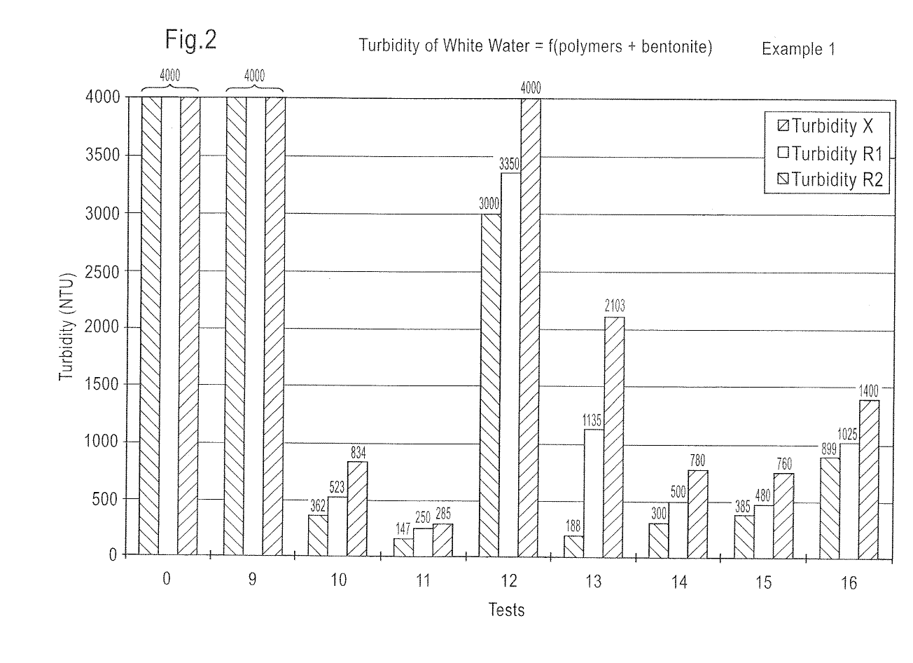

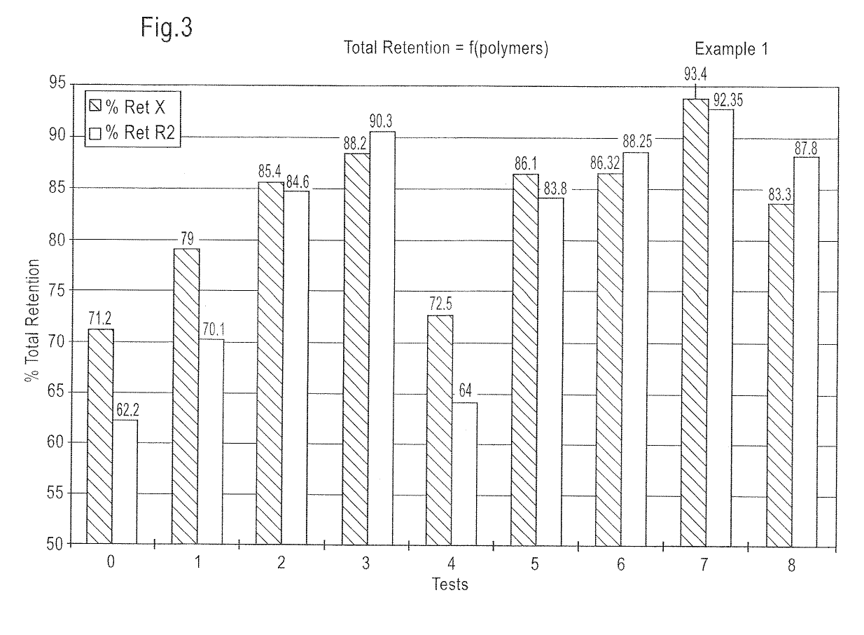

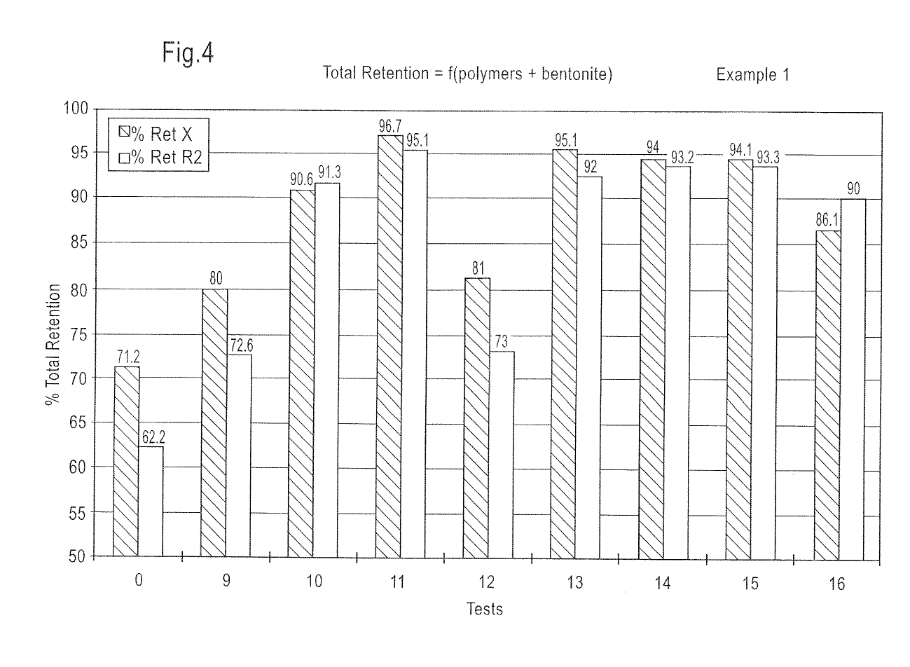

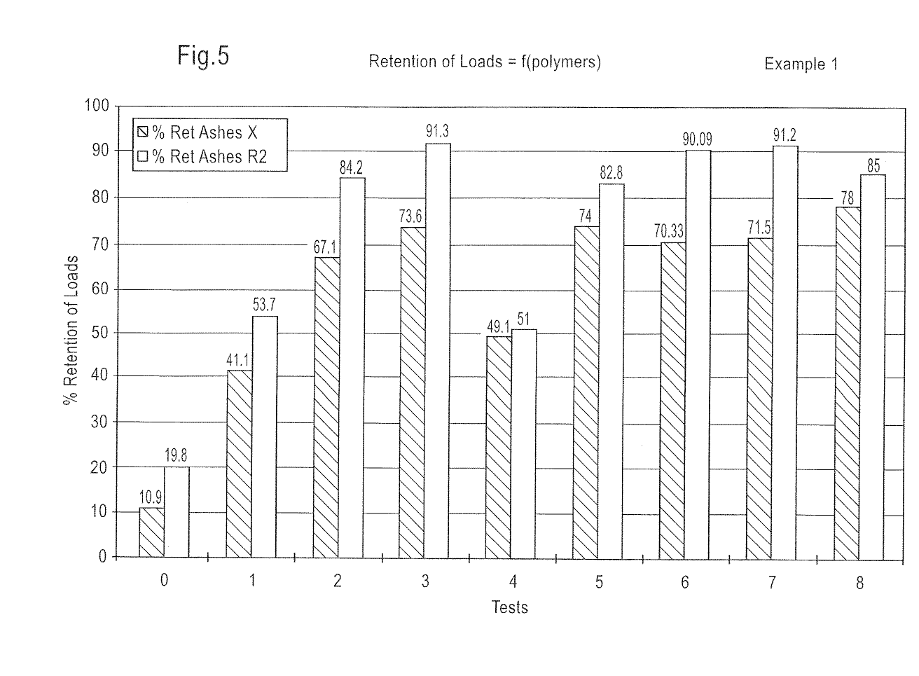

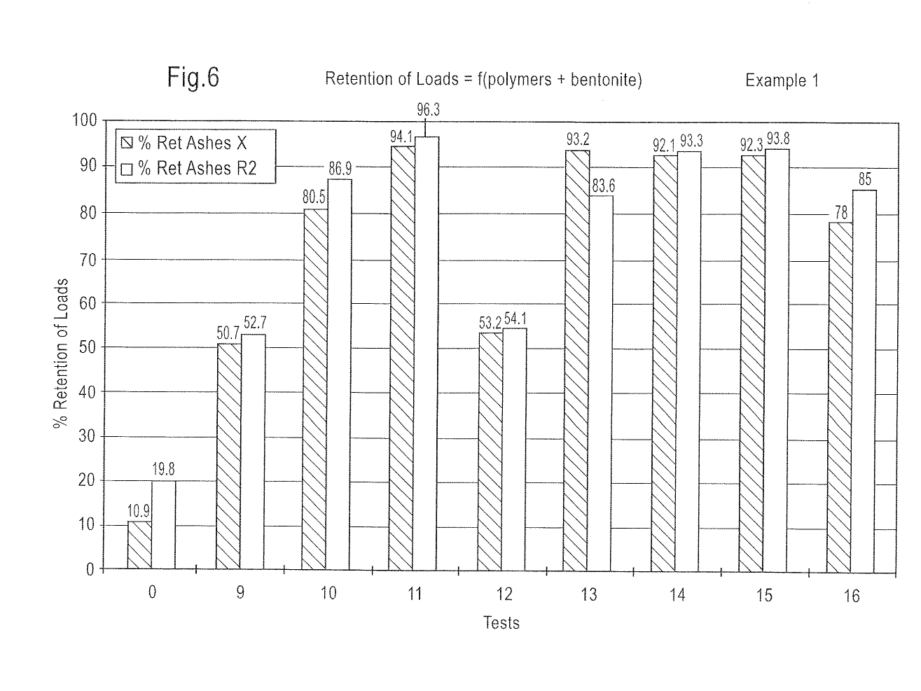

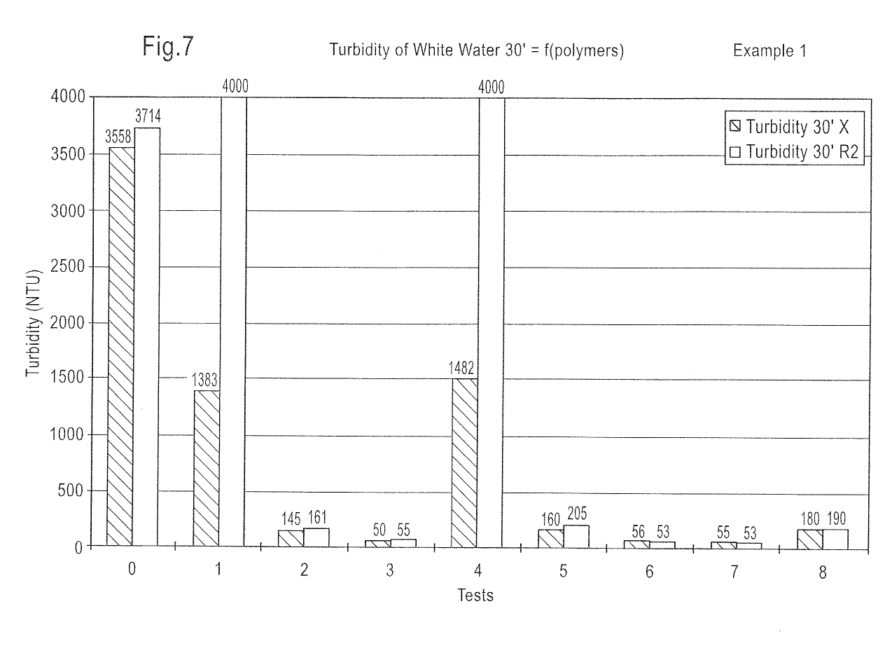

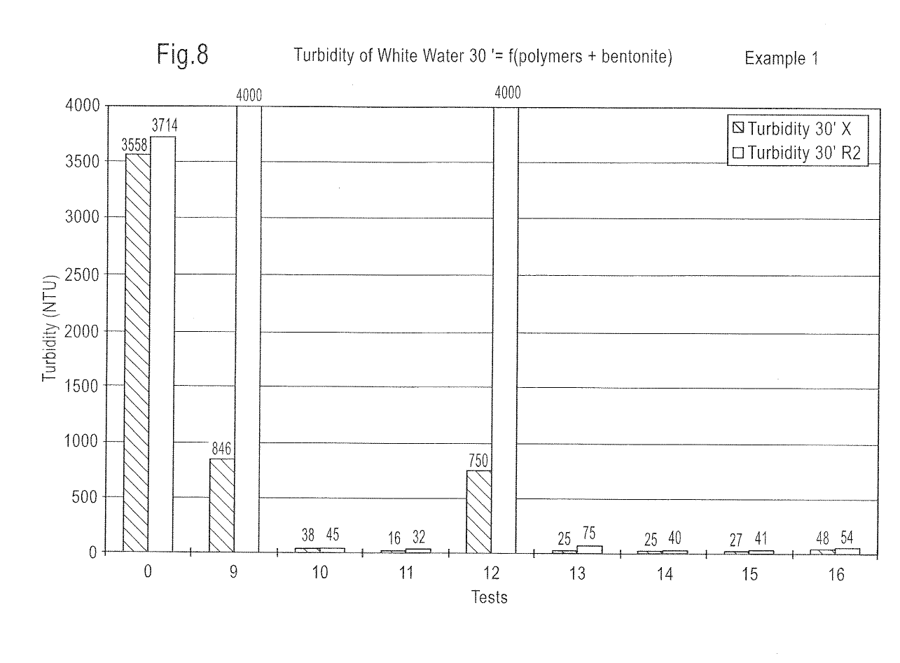

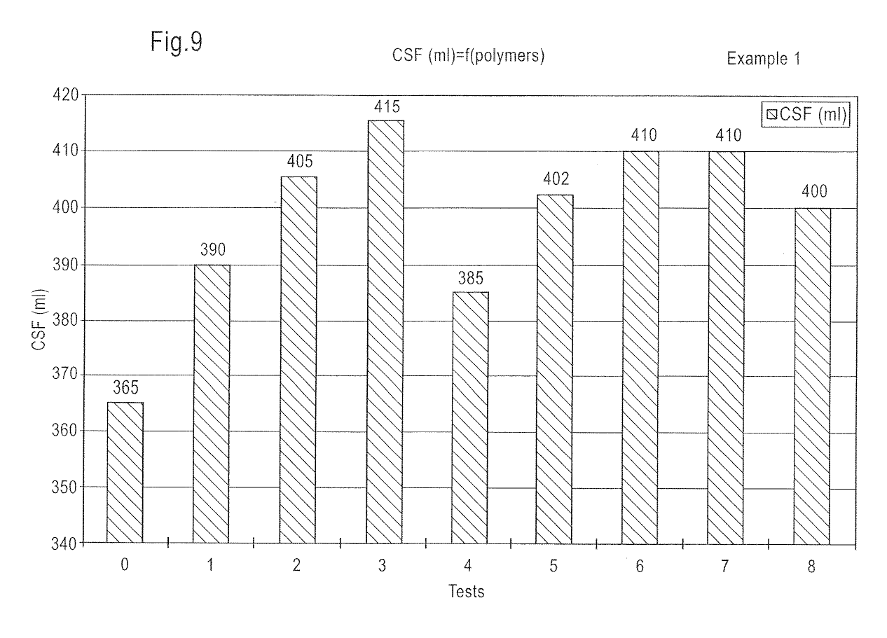

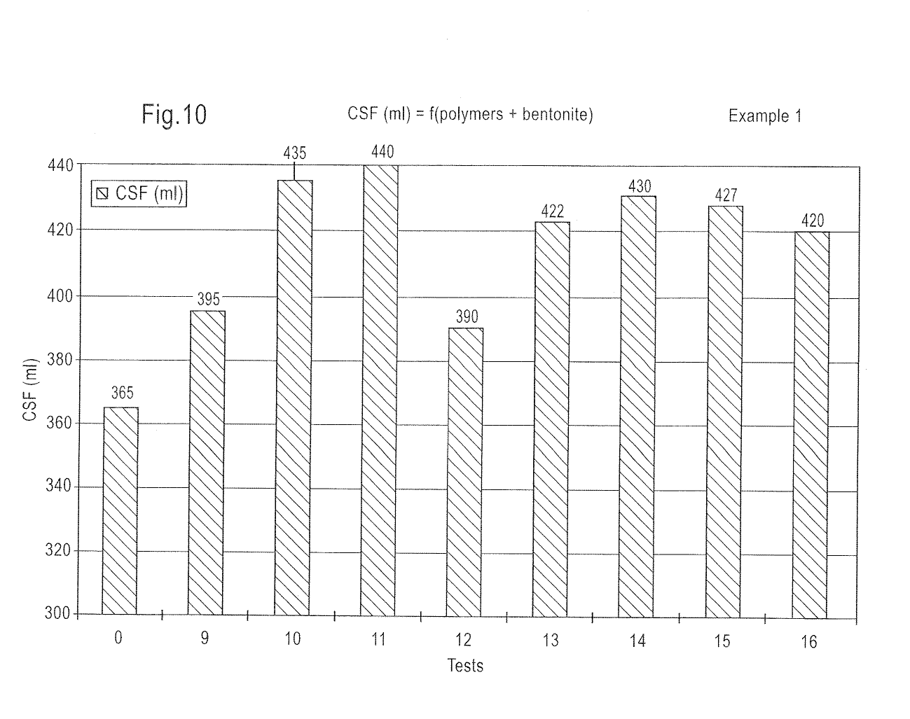

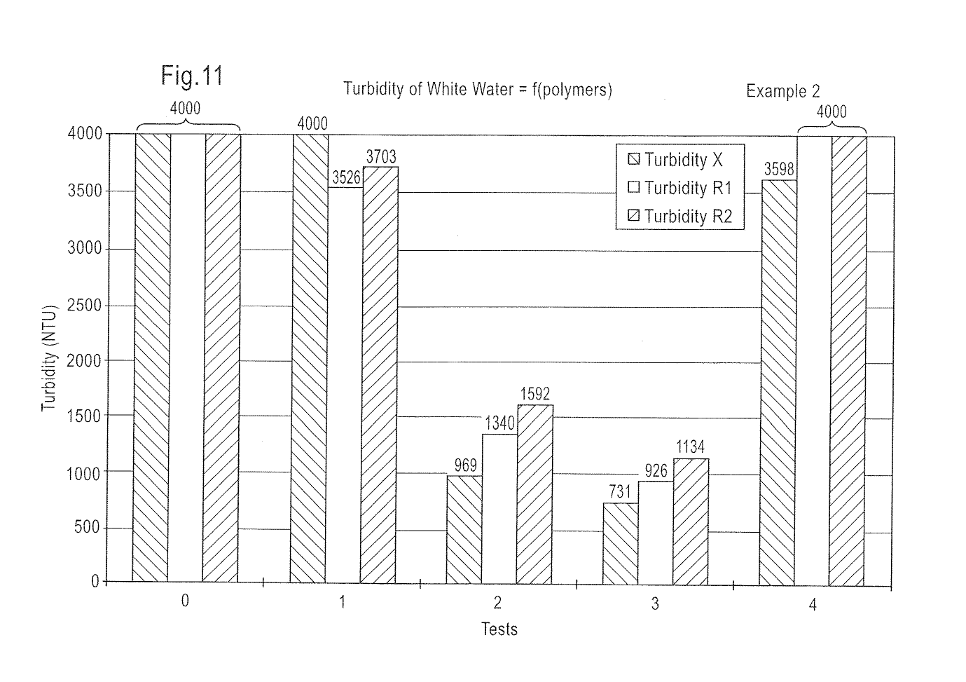

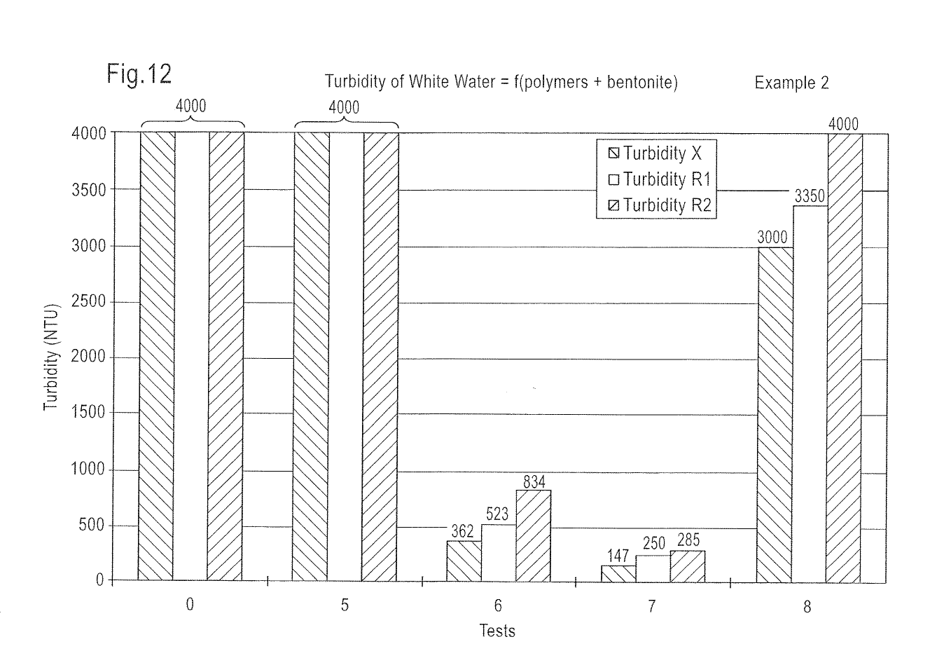

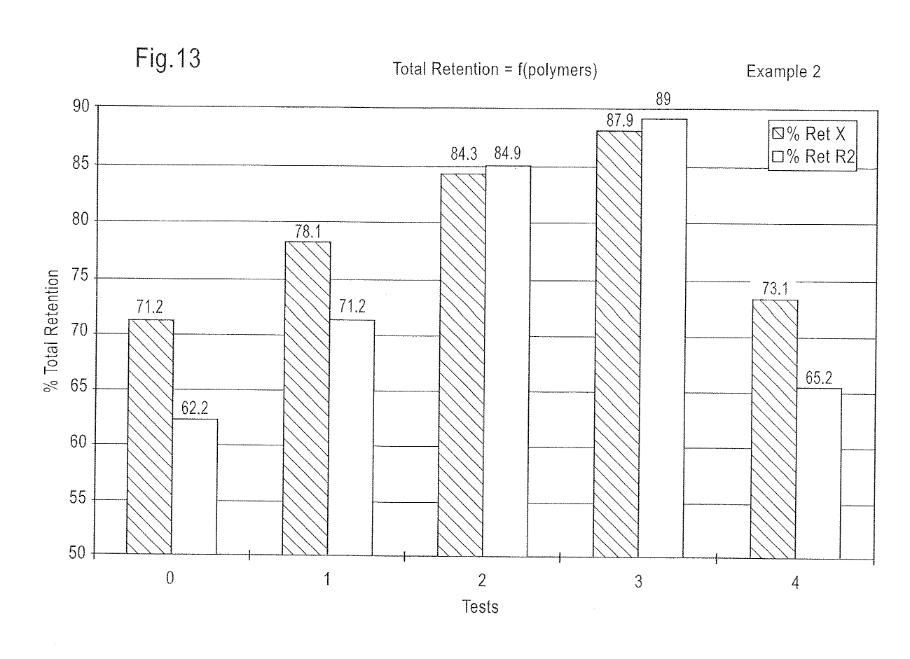

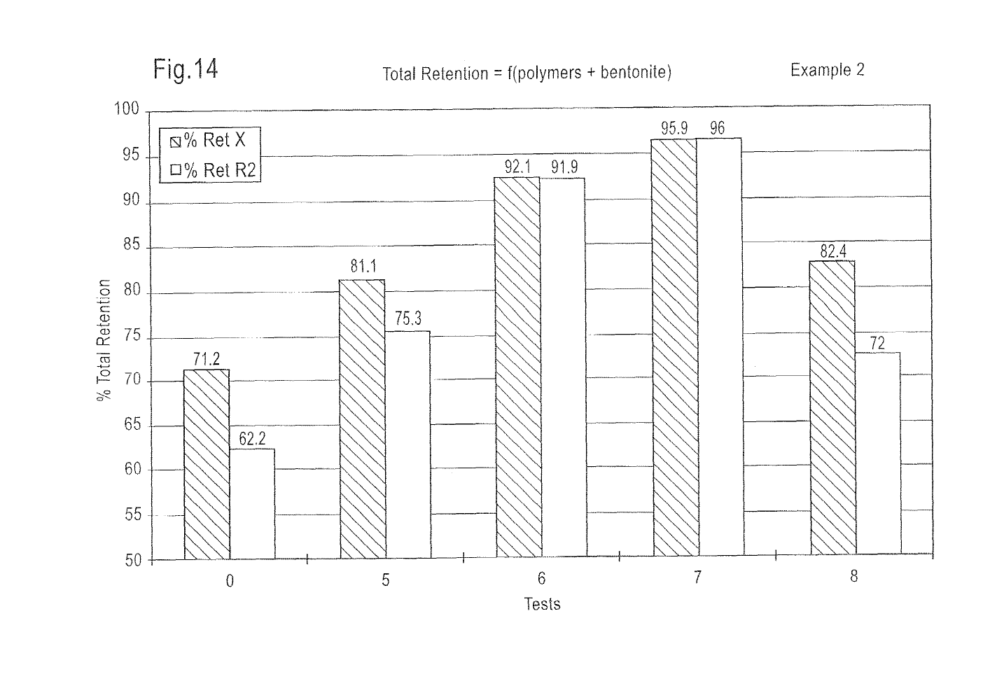

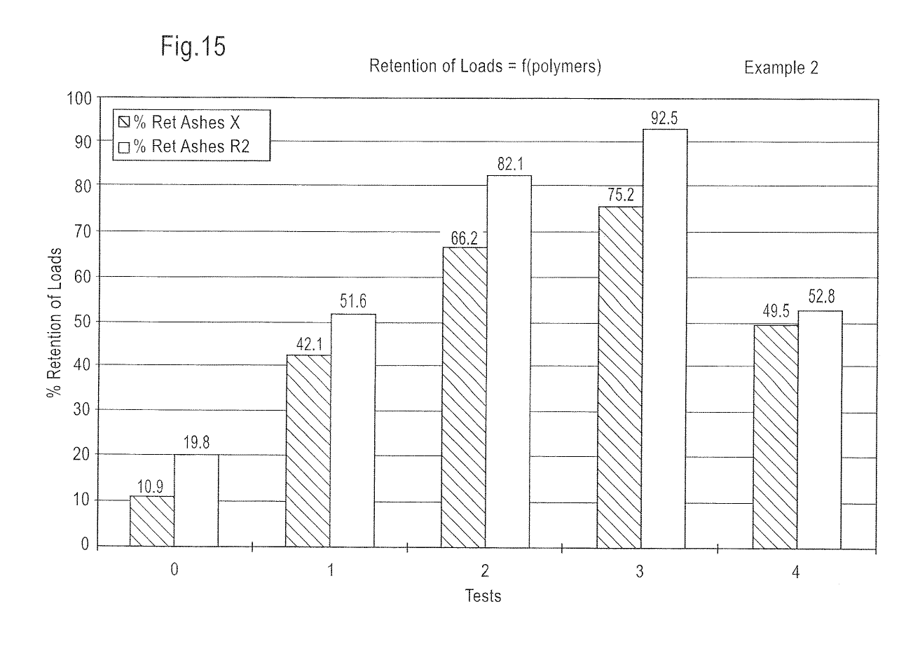

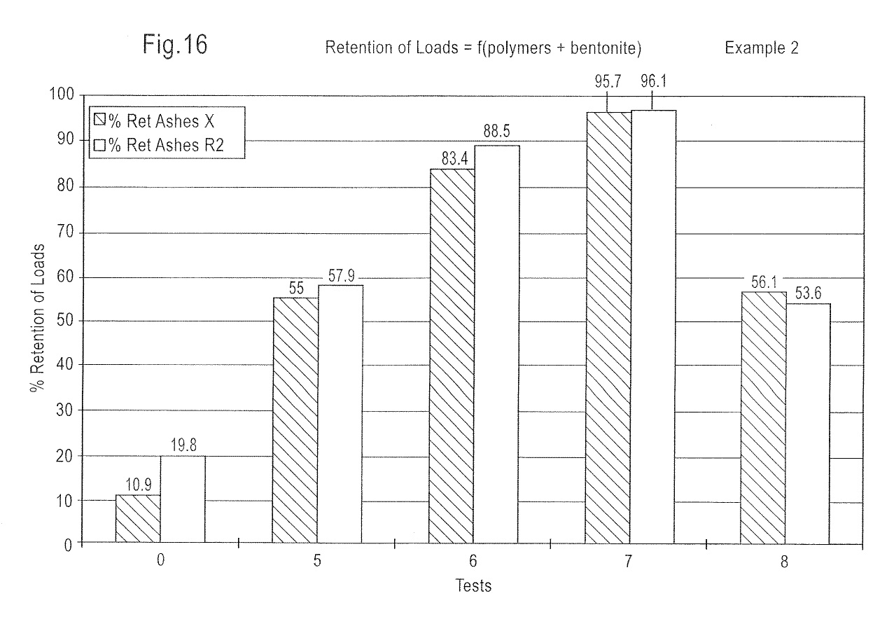

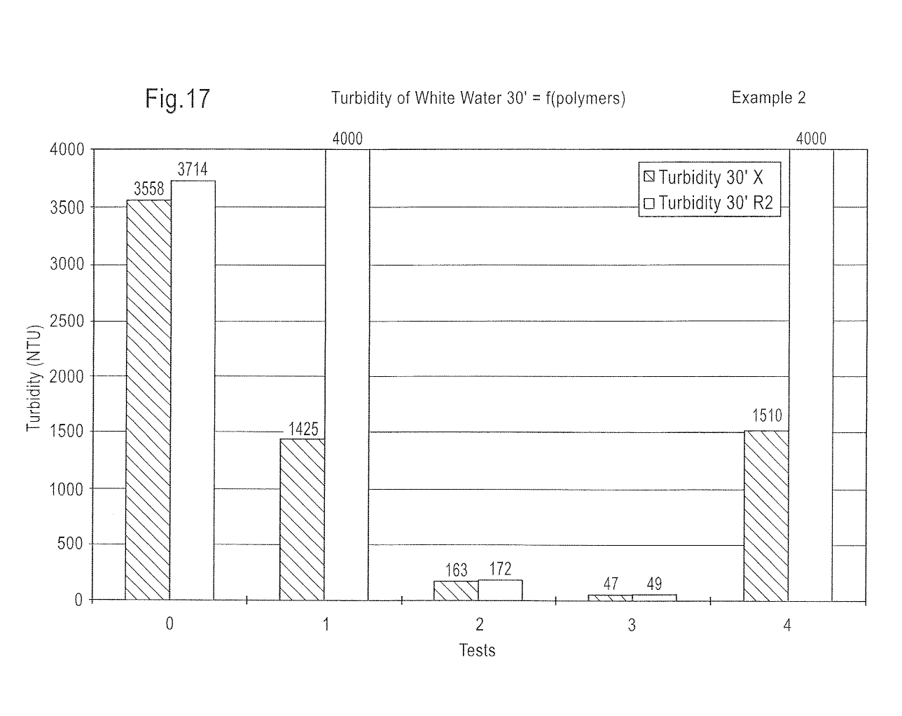

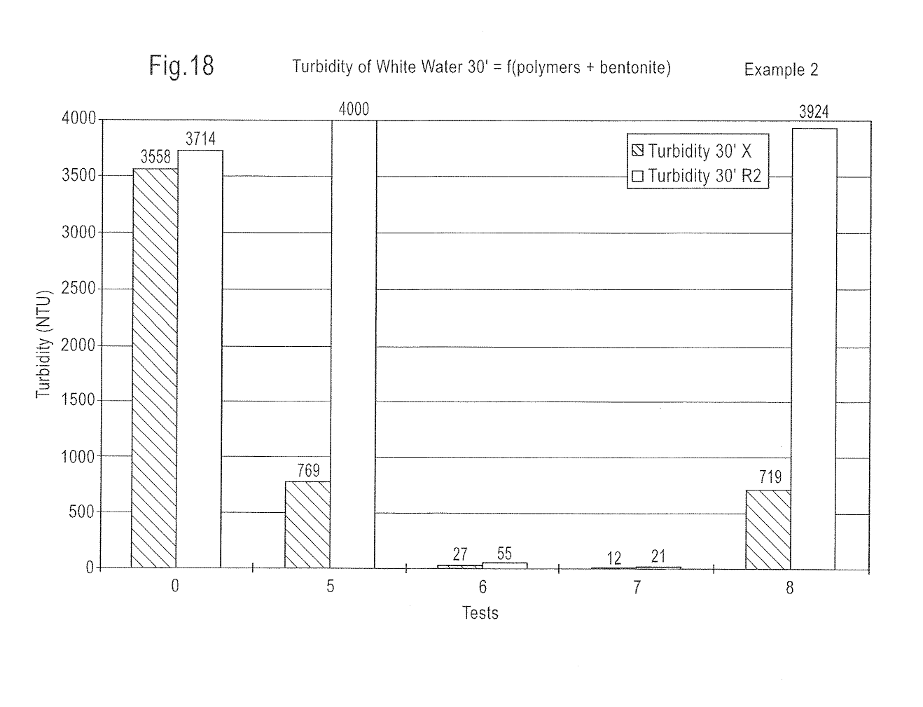

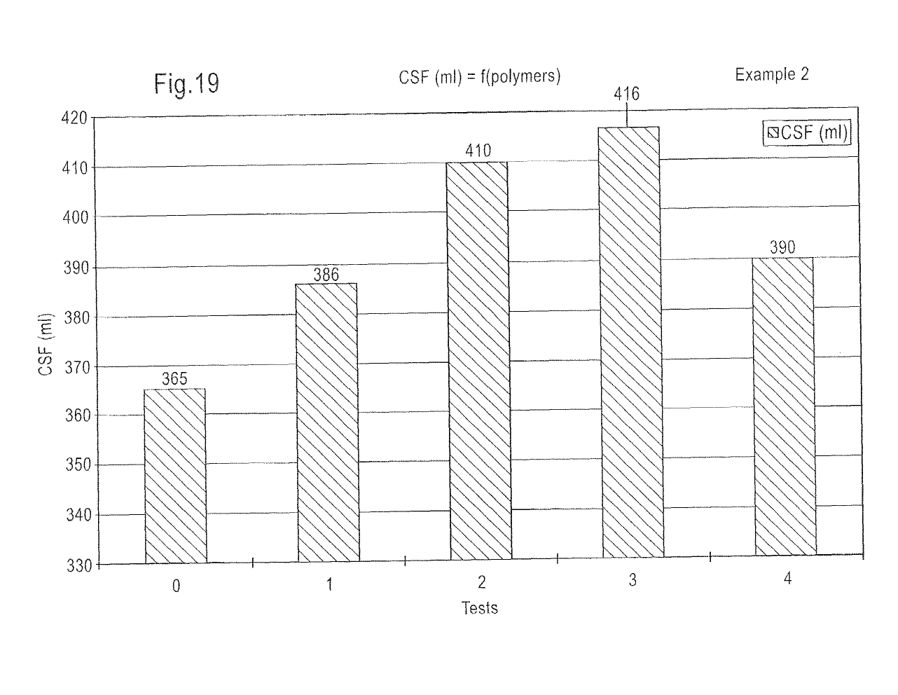

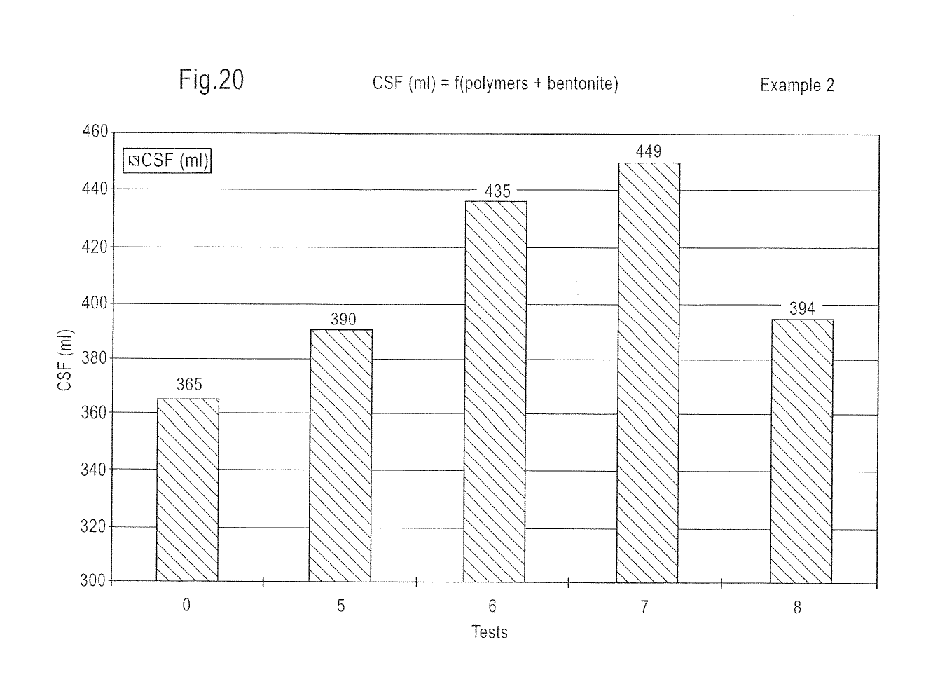

### Notes for FIGS. 1-20 Below:

X=so-called first-pass measurement
R1=so-called second pass-measurement (1st recycling)
R2=so-called third pass measurement (2nd recycling)
Ash %=% by weight of ash retained (=filler retention) in the sheet/weight of the sheet.

### Comments on the Results:

The cross-linked polymers have no advantage as to the flocculation and the retention of fines and fillers in spite of the high rate of shear applied during the process to the fibrous mass (and not applied to the polymer itself), in this case 1,500 rpm, which is characteristic of this type of microparticulate retention systems They show a poor capture of fillers and colloidal matter, since no reduction in turbidity is observed.

The combination with bentonite does not significantly improve the effectiveness in terms of retention and only slightly improves the effectiveness in terms of drainage.

As for the linear polymer, its behavior follows the tendency to improve the retention of fillers and fines.

The combination according to the invention of a branched polymer in reverse phase emulsion and bentonite provides a net gain in filler retention and in total retention, and is revealed to be superior to the known linear polymer/bentonite system.

The coagulation capacity is better for a branched polymer in emulsion, which translates into an excellent reduction in the turbidity at 30′ (30 min.).

The R 52 test and the R 102 test show that the invention makes it possible to obtain branched products having UL viscosities higher than those accessible through gel polymerization as described in European patient 0 574 335. Any attempt to reach such highly advantageous UL viscosity values using a gel polymerization process with drying into a powder would result in a product that was totally insoluble and therefore totally unusable in the industry.

The SD 102 test shows that the polymer used in the form of a solution in water of the powder obtained by drying the reverse phase emulsion from the synthesis of the polymer behaves like the polymer used in the form of the solution in water of said synthetic reverse phase emulsion. In particular, no degradation of the polymer is observed during the stage for drying by means of spray-drying.

It is useful to compare the R 52 test to the FO 4198 test (powder), since the polymers have the same chemistry, hence the same cationicity, and the same % of MBA, while the R52 of the invention is far superior to the powder in terms of drainage and retention (96.3 as compared to 87.6); compare also the turbidity in NTU after 30 minutes, 32 as compared to 75 NTU units.

Such UL viscosity values specifically result in substantially improved drainage.

The invention also relates to a novel retention aid for the production of a sheet of paper, paperboard or the like, which is comprised of a branched acrylic (co)polymer as described above, in reverse phase emulsion, which is characterized in that its UL viscosity is >3, or >3.5 or >4. Said agent can be used either in emulsion, inverted in water, or in a solution of the powder obtained by drying the emulsion, as described above.

### Example 2

### Production of a Branched Acrylamidopropyltrimethylammonium Chloride (APTAC) Based Polymer in the (Corm of a Reverse Phase Oil-in-Water Emulsion

In a reactor A, the constituents of the organic phase of the emulsion to be synthesized are mixed at the ambient temperature.
a) Organic phase
   252 g of Exxsol D100
   18 g of Span 80
   4 g of Hypermer 2296
b) In a beaker B, the phase of the emulsion to be produced is prepared by mixing:
   378 g of acrylamide at 50%
   102.2 g of acrylamidopropyltrimethylamonium chloride (60%)
   245.7 g of water
   0.5 g of methylenebisacrylamide at 0.25%
   0.75 ml of sodium bromate at 50 g/1
   20 ppm of sodium hypophosphite relative to the active material
   0.29 ml of Versenex at 200 g/1

The contents of B are mixed into A under agitation. After the mixing of the phases, the emulsion is sheared in the mixer for 1 minute in order to create the reverse-phase emulsion. The emulsion is then degassed by means of a nitrogen bubbling; then after 20 minutes, the gradual addition of the metabisulfite causes the initiation followed by the polymerization.

Once the reaction is finished, a “burn out” is carried out in order to reduce the free monomer content.

The emulsion is then incorporated with its inverting surfactant in order to subsequently free the polymer in the aqueous phase.

### Table of Example 2:

| | MBA | NaH₂PO₂ | UL | IR (1) | IVR (2) | |
|---|---|---|---|---|---|---|
| Test | PPM | ppm (*) | viscosity | (%) | (%) | State |
| M 52 | 5 | 20 | 4.20 | 14.2 | 0 | Branched |
| M 102 | 10 | 20 | 3.34 | 21.3 | 0 | Branched |
| XM 104 | 10 | 40 | 2.11 | 37 | 50 | Cross- |
| | | | | | | linked |
| XM 204 | 20 | 40 | 1.94 | 58 | 55 | Cross- |
| | | | | | | linked |
| EK 190 | 0 | 15 | 4.35 | 0 | 0 | Linear |
| EK 190 | 5 | 0 | 1.85 | 78 | 60 | Cross- |
| BD | | | | | | linked |

EK 190: a standard emulsion of a copolymer of acrylamide and crylamidopropyltrimethylammonium chloride, linear.

### Procedure for Testing the Emulsions

(identical to that of Example 1)

### Comments on the Results:

The results invite the same comments as those of Example 1 and confirm the great advantage of the present invention.

The invention also relates to the novel retention aids described above, characterized in that they consist of, or comprise, at least one branched (co)polymer of the type described, prepared in reverse phase emulsion, intended to cooperate with a secondary retention aid after an intermediate stage for shearing the paper pulp, as well as to the processes for producing sheets of paper, paperboard or the like using the agents according to the invention or the process according to the invention, and the sheets of paper, paperboard and the like thus obtained.

Said agent can be used either in emulsion inverted in water, or in a solution of the powder obtained by drying the emulsion, as described above.

1. Process for manufacturing a sheet of paper or paperboard having improved retention and drainage properties comprising the step of:
utilizing a dual system of (a) an acrylic polymer as a primary retention agent and (b) bentonite as a secondary retention agent, the introductions of which are separated by a step for shearing a suspension or fibrous mass or paper pulp,
wherein said acrylic polymer is a branched, cationic, acrylic (co)polymer prepared in the form of a reverse phase water-in-oil emulsion, used either in emulsion reversed in water, or in a solution of the powder obtained by drying the emulsion, and
wherein the branched, cationic, acrylic (co)polymer prepared in the form of a reverse phase water-in-oil emulsion has a UL viscosity that is greater than 3 cps.

2. Process according to claim 1, characterized in that the branched acrylic (co)polymer prepared in reverse phase emulsion is introduced into the paper pulp at a concentration of 0.03 to 1% by weight of the dry weight of the fibrous suspension of paper pulp.

3. Process according to claim 1, characterized in that the branched acrylic (co)polymer prepared in reverse phase emulsion is a cationic copolymer of acrylamide and of an unsaturated cationic ethylenic monomer selected from the group consisting of dimethylaminoethyl acrylate (ADAME) and dimethylaminoethyl methacrylate (MADAME), that is quaternized or salified by a compound selected from the group consisting of benzyl chloride, methyl chloride, alkyl or aryl chlorides, dimethyl sulfate, diallyldimethylammonium chloride (DADMAC), acrylamidopropyltrimethylammonium chloride (APTAC), and methacrylamidopropyltrimethylammonium chloride (MAPTAC).

4. Process according to claim 1, characterized in that the branched acrylic (co)polymer in reverse phase emulsion is branched by means of a branching agent constituted by a polyfunctional compound having at least two reagent groups chosen from the group comprising double bonds, aldehyde bonds or epoxy bonds.

5. Process according to claim 1, characterized in that the branched acrylic (co)polymer in reverse phase emulsion is branched by means of a branching agent constituted by methylenebisacrylamide (MBA) at a concentration of 5 to 200 moles per million moles of monomers.

6. Process according to claim 1, characterized in that the bentonite is a semisodic bentonite, used at a rate of 0.1 to 0.5 percent of the dry weight of the fibrous suspension.

7. Process according to claim 5, characterized in that the pulp used, which contains filler, is diluted, after which the (co)polymer is added as the main retention agent, then the bentonite is added as the secondary retention agent, optionally pretreated with an electrolyte, as the secondary retention agent.

8. Process according to claim 7, characterized in that the quantity of branched acrylic (co)polymer, introduced either in reverse phase water-in-oil emulsion reversed in water, or in a solution of the powder obtained by drying the emulsion, is between 0.03 and 1 of dry pulp.

9. Process according to claim 7, characterized in that a quantity of branched acrylic (co)polymer, introduced either in reverse phase water-in-oil emulsion reversed in water, or in a solution of the powder obtained by drying the emulsion, is between 0.15 and 0.5%.

10. Process according to claim 1, characterized in that the branched, cationic, acrylic (co)polymer prepared in reverse phase emulsion is injected or introduced, either in emulsion reversed in water, or in a solution of the powder obtained by drying the emulsion, before a shearing stage, into the paper pulp or fibrous mass to be flocculated, which is diluted into diluted paper pulp or thin stock that is a pulp diluted to about 0.7-1.5% solid matter that can be cellulose fibers, fillers, and/or other components typically used in papermaking.

11. Process according to claim 1, characterized in that some of the branched, cationic, acrylic (co)polymer in emulsion is introduced at the level of the stage for preparing the thick stock with about 5% or more solid matter, or at the level of the preparation of the thick stock before a shearing stage.

12. Novel retention agent for the manufacture of a sheet of paper or paperboard characterized in that it comprises a) a branched polyacrylamide or optionally a branched acrylic (co)polymer which is a cationic copolymer of acrylamide and an unsaturated cationic ethylenic monomer, selected from the group consisting of dimethylaminoethyl acrylate (ADAME) and dimethylaminoethyl methacrylate (MADAME), that is quaternized or salified by a compound selected from the group consisting of different acids and quaternizing agents, benzyl chloride, methyl chloride, alkyl or aryl chlorides, dimethyl sulfate, diallyldimethylammonium chloride (DADMAC), acrylamidopropyltrimethylammonium chloride (APTAC), and methacrylamidopropyltrimethylammonium chloride (MAPTAC) in reverse phase emulsion, either in reverse phase emulsion dissolved or reversed in water, or in a solution of the powder obtained by drying or spray-drying the reverse phase emulsion; in combination with bentonite, and in combination with a branching agent.

13. Novel retention agent for the manufacture of a sheet of paper or paperboard according to claim 12, characterized in that its UL viscosity is greater than 3 cps.

14. Sheet of paper or paperboard obtained utilizing a retention agent according to claim 12.

15. Sheet of paper or paperboard produced by a process according to claim 1.

16. A process for manufacturing a sheet of paper or paperboard having improved retention and drainage properties, comprising the steps of:
introducing an acrylic polymer as a primary retention agent to a suspension or fibrous mass or paper pulp wherein said acrylic polymer is a branched, cationic, acrylic(co)polymer in the form of a reverse phase water-in-oil emulsion used either in emulsion reversed in water, or in a solution of powder obtained by drying the emulsion;
shearing the suspension or fibrous mass paper pulp; and
introducing bentonite as a secondary retention agent.

17. The method of claim 3 wherein said unsaturated cationicethylenic monomer is dimethylaminoethyl acrylate (ADAME).

18. The method of claim 3 wherein said unsaturated cationic ethylenic monomer is dimethylaminoethyl methacrylate (MADAME).

19. Process according to claim 1, wherein the dual system has a UL viscosity that is greater than 3.5 cps.

20. Process according to claim 1, wherein the dual system has a UL viscosity that is greater than 4 cps.

21. Process according to claim 7, wherein, before the bentonite is added, a shearing stage is carried out in the mixing pump or fan pump.

22. Novel retention agent according to claim 13 wherein its UL viscosity is greater than 3.5 cps.

23. Novel retention agent according to claim 13 wherein its UL viscosity is greater than 4 cps.
